(19) United States
(12) Patent Application Publication
(10) Pub. No.: US 2022/0064423 A1
(43) Pub. Date: Mar. 3, 2022

(54) THERMOPLASTIC VINYL POLYMER COMPOSITIONS CONTAINING BRANCHED VINYL POLYMERS, AND PRODUCTION AND USE THEREOF

(71) Applicant: Friedrich-Schiller-Universitaet Jena, Jena (DE)

(72) Inventors: Felix Helmut SCHACHER, Jena (DE); Oliver ECKARDT, Jena (DE)

(21) Appl. No.: 17/281,007

(22) PCT Filed: Sep. 19, 2019
(86) PCT No.: PCT/EP2019/000273

§ 371 Date: Oct. 1, 2021

(30) Foreign Application Priority Data
Sep. 29, 2018 (DE) 10 2018 007 714.5

(51) Int. Cl. C08L 25/06; C08L 33/12

(52) U.S. Cl. CPC C08L 25/06; C08L 2205/025; C08L 33/12

(57) ABSTRACT

Disclosed are compositions comprising
a) thermoplastic vinyl polymers, and
b) branched vinyl polymers which are derived from monofunctional vinyl compounds and from multifunctional vinyl compounds, and which have been prepared by radical copolymerisation in the presence of chain transfer agents.

The branched vinyl polymers can be used as plasticisers for thermoplastic vinyl polymers or as flow improvers for fluids.

The invention relates to compositions comprising thermoplastic vinyl polymers and branched vinyl polymers and the use of these branched vinyl polymers as plasticizers for thermoplastic vinyl polymers or as flow-enhancing additives for fluids.

When processing polymers into different plastic products, a wide variety of additives are added to them in order to specifically adjust certain properties of the plastic products. In addition to small amounts of stabilizers and dyes, so-called rheology modifiers and/or plasticizers are often added to the usually brittle polymers. In the case of plasticizers, a distinction is made between external and internal plasticizers.

In the external plasticisation, the plasticizer is not covalently incorporated into the polymer, but interacts with the polymer via its polar groups and thus increases the chain mobility. Typical plasticizers from this group include diethylhexyl phthalate (DEHP) (also called dioctyl phthalate (DOP)), Mesamoll comprising alkyl sulphonic acid ester of phenol (ASE), Hexamoll (DINCH), citric acid-based plasticizers, such as citric acid triethyl ester or adipic acid-based plasticizers, such as diethylhexyl adipate or diethyloctyl adipate.

In addition to these methods referred to as external plasticisation, there is also known the so-called internal plasticisation, in which the plasticizer is introduced during copolymerization. In contrast to the external plasticisation, in which the plasticizer is linked to the macromolecules via dipole interactions, the plasticizer in internal plasticising becomes part of the macromolecule. As a result, the plastic remains permanently soft and there is no diffusing out of the plasticizer. For example, vinyl chloride is copolymerized with vinyl acetate. But other additives for the copolymerization of vinyl chloride, such as maleic acid, ethene, methylvinyl ether or acrylic acid methyl ester, are also possible.

In addition, so-called extenders are known. These are secondary plasticisers that have a moderate polarity and are only used in coordination with an actual plasticizer. They are used to improve processing and to reduce cost of the plastic molding material.

Due to their size and optionally their electrostatic interactions, plasticizers are able to accumulate between the polymer chains and thus to increase the chain-mobility. This effect lowers the glass transition temperature and thus leads to flexible, soft and more elastic materials even at low temperatures.

The most commonly used plasticizer in 2016 was DEHP at 3.07 million tons, which is used, among other materials, for polyvinyl chloride (PVC) materials. In combination with diisononyl phthalate (DINP) and diisododecyl phthalate (DIDP), these 3 phthalates formed around ⅓ of the world's production of plasticizers in 2016. Soft PVC, for example, can consist of up to 40% of plasticizers. Due to the effect on the human body that has not yet been fully clarified and their easy release (outgassing), phthalates and phthalate-like plasticizers are considered to be questionable additives in plastics. Certain phthalate-based plasticizers are suspected of causing infertility or affecting the neurological functions of humans. In 2005, the European Union adopted Directive 2005/84/EG prohibiting the use of DEHP, dibutyl phthalate and benzylbutyl phthalate in toys or baby articles and children's articles. DIDP and DINP also have a ban in Europe on baby articles and children's toys, which can be put into the mouth.

Despite these prohibitions and guidelines, there exist countless other phthalate-based plasticizers that are used in plastics. For these reasons, novel phthalate-free plasticizers must be found. A first substitute for phthalates as a plasticizer is DINCH (1, 2-cyclohexane dicarboxylic acid diisononyl ester) (cf. WO 99/32427 A1). It has a phthalate-like structure (cyclohexane base body), but is classified as toxicologically harmless and is often used in medical devices, or as packaging material for food.

Based on this work, the use of dialkyl-cyclohexane-1,3-dicarboxylic acid esters in synthetic materials was described in WO 00/78704 A1. The long-term effects on the human organism are so far insufficiently investigated.

A biologically produced plasticizer could be produced from soybean oil. After epoxidation, the epoxidized soybean oil (ESBO) is used as a plasticizer and for stabilizing PVC. However, due to the epoxy groups in the ESBO, this can lead to irritation and allergies if incompletely installed in the plastic. In addition, ESBO is lipophilic and can be easily excavated from the plastic.

Oligomers or polymeric systems were used to reduce release of plasticizers. This includes Mesamoll which consists of a mixture of low molecular weight secondary alkane sulphonic acid phenyl esters and unbranched alkanes.

Adipates are important representatives of phthalate-free plasticizers. They consist of low molecular weight esters of adipic acid with C₈-C₁₀ alcohols. Here it is also possible to use polyhydric alcohols and thus obtain an oligomeric or polymeric plasticizer.

WO 2017/055432 A1 discloses an extension of this system with branched or unbranched C₂-C₁₂ alkane diols and branched or unbranched C₂-C₈ alkane acids with polymerization degrees of 1-100. In all described and already published documents mainly low molecular weight substances or linear polymers are used.

Only in WO 2017/055432 A1 branched molecules are described. It should be noted, however, that these contain only low molecular weight branches in the backbone of the polymer. Since these are polyesters that are subject to hydrolytic degradation, they can be degraded in acidic or basic conditions. With increasing operating time of the product this results in a decrease in flexibility and in an increase in brittleness.

US 2013/0018149 A1 discloses star-shaped ethylene polymers with at least three branches. These polymers are derived from a copolymer of ethylene and maleic acid anhydride on which vinyl-terminated polyethylene has been grafted.

US 2013/0172493 A1 discloses a process for the production of dendritic hydrocarbon polymers. Therein, telechelic hydrocarbon polymers are reacted with multifunctional coupling agents, so that dendritic hydrocarbon polymers are formed.

U.S. Pat. No. 6,037,444 A describes selective chemical reactions and thereby produced polymers with a controlled structure. This document discloses the production of dendrimers with selected functional groups. These dendrimers can be used, among other things, as reactive plasticizers in thermoplastic compositions.

U.S. Pat. No. 5,998,565 A discloses a process for producing a mixture from the melt. To this, a plastic and an additive, which is combined with a dendrimer having functional end groups, are mixed together in the melt. The functional end groups are at least partially modifying groups that are compatible with the plastic.

Linear and branched vinyl polymers are already known and have been used for years. From an economic point of view, it is crucial that vinyl polymers are synthetically easily accessible and that plasticised products made of vinyl polymers are durable for as long as possible without the plasticizer or its effect getting lost.

As explained above, phthalate-free softeners, such as DINCH or ESBO, already exist in the prior art. The disadvantage of these materials, however, is the continued simple release of the plasticizer from the plastic, which leads to a temporal increase in brittleness and decrease in flexibility of the plasticised products.

Esters of adipic acid are also often used. However, since these decompose in acidic or alkaline environments, this also leads to an increase in brittleness and a decrease in flexibility over the utilisation time of a possible product.

As explained above, polymeric or oligomeric plasticizers are already used in the plastics industry. However, since these are often polyadipates or oligoalkylsulfonic acid phenyl esters, the miscibility with the corresponding plastic is not always given.

Another problem with the previous solutions is the sometimes very poor miscibility between plasticizer and plastic, which leads to an inhomogeneous distribution of the plasticizer in the material.

It has now been found that selected highly branched polymers, which can be easily produced according to the “Strathclyde method”, are suitable as plasticizers for vinyl polymers, and that these plasticizers do not have the problems described above.

In addition, it was found that selected highly branched polymers, which can be easily produced according to the “Strathclyde method”, are suitable as flow enhancers for vinyl polymers or other fluids.

Thus, with the present invention, a novel technology is provided for plasticising vinyl polymers or for modifying the rheology of fluids, in particular of vinyl polymer melts.

The invention relates to compositions comprising
a) thermoplastic vinylpolymers, and
b) branched vinylpolymers which are derived from monofunctional vinyl compounds and from multifunctional, preferably from bifunctional vinyl compounds, and which have been prepared by radical copolymerisation in the presence of chain transfer agents, such as organic mercapto compounds or organic halogen compounds.

The compositions of the invention are preparations which are solid at room temperature (25° C.). These can be plastically deformed by heating. This process is reversible. This means that this state can be repeated as many times as desired by cooling and reheating.

The thermoplastic vinyl polymers of component a) are plastics comprising little or non branched carbon chains, i.e. linear or essentially linear carbon chains, which are connected only by weak physical bonds. These binding forces are more effective if the chains are aligned in parallel. Such zones are called crystalline, in contrast to amorphous (disordered) zones in which the macromolecules are entangled. Thermoplastic vinyl polymers of component a) do not contain any structural units derived from multifunctional monomers or up to 1 mol % in particular from 0 to 0.5 mol % only of structural units derived from multifunctional monomers.

Branched vinyl polymers of component b) contain at least more than 1 mol % in particular at least 2 mol % of structural units derived from multifunctional monomers. These vinyl polymers have branched carbon chains that are not or only to a small extent crosslinked with other carbon chains. The degree of crosslinking (=molar proportion of interlinked branched vinyl polymers based on the total proportion of branched vinyl polymers) is typically less than 50%, preferably less than 10% and most preferably less than 5%.

The branched vinyl polymers of component b) are plastics constructed from branched carbon chains with a selected branching pattern and are produced using the “Strathclyde method”.

Different classes of branched polymers are distinguished. A subset of branched vinyl polymers includes dendritic vinyl polymers. These are also called “sequentially branched vinyl polymers”. They differ from linear vinyl polymers by the presence of subsequent branches. Two classes of dendritic vinyl polymers can be distinguished. On the one hand, they can be structurally “perfect dendrimeric vinyl polymers” and on the other hand structurally “not perfect dendrimeric vinyl polymers”.

Another subset of branched but non-crosslinked polymers arises when linear chain molecules are bound to a polyfunctional core building block. This results in so-called “star polymers”.

Perfect dendrimeric vinyl polymers are obtained when well-defined branching points are built into the individual arms of a vinyl star polymer, so that a perfectly branched, centrisymmetric architecture develops.

If, on the other hand, statistical branching centers are introduced into the individual branches of a vinyl star polymer, not perfect dendrimeric vinyl polymers are produced. These have no radial symmetry.

Another group of branched vinyl polymers can be produced using the “Strathclyde method” described below. According to the invention, such branched polymers are used as component b).

Vinyl polymers or polymers derived from vinyl monomers within the meaning of this description are polymers derived from monomers of the structure (H₂C═CH)ₚ—X, in which p is 1, 2, 3 or 4. Monomers with p=1 have a vinyl group and lead to thermoplastic vinyl polymers. Monomers with p=2, 3 or 4 have several vinyl groups and lead to branched vinyl polymers. These monomers thus consist of at least one polymerizable vinyl group and one substituent X. This, in turn, can consist of only one atom, as in the case of X═F (vinyl fluoride), X═Cl (vinyl chloride), X═H (ethylene), or X═Br (vinyl bromide); or it may consist of an atomic group, as in the case of X=alkyl (1-alkene); or X=Aryl, such as styrene; or X═OR, such as vinyl ethers; or X═O—CO—R, as in the case of vinyl esters; or X═COOR, as in the case of vinyl carboxylic acids, e.g. acrylic acid or methacrylic acid.

Examples of vinyl polymers are polyethylene, polypropylene, polyvinyl chloride, polystyrene, polytetrafluoroethylene, polyacrylates, polymethacrylates, such as polymethyl methacrylate, polyacrylonitrile or polyacrylamide.

Surprisingly, it was found that by adding branched vinyl-based polymers manufactured by the “Strathclyde method” developed by Sherrington to linear vinyl polymers of similar structure, such as polystyrene, polyvinyl chloride or polymethyl methacrylate, the glass transition temperature of the mixture can be reduced. This results in a more flexible and softer material. In addition, it was found that branched vinyl-based polymers produced by the “Strathclyde method” developed by Sherrington significantly reduce the viscosity of melts of linear vinyl polymers of similar structure or other fluids, so that these branched vinyl polymers can be used as flow enhancers.

Due to a similar chemical structure of the branched polymers in relation to their linear analogues, an almost ideal miscibility of the two components is given.

According to the invention, branched vinyl polymers produced according to the “Strathclyde method” are added to a linear vinyl polymer in order to reduce the glass transition temperature and/or to enhance flow.

The “Strathclyde method” is described, for example, by N. O'Brien' A. McKee, D. C. Sherrington, A. T. Slark and A. Titterton in Polymer 2000, 41, 6027-6031. In this method, vinyl group-containing monomers, such as (meth)acrylates, styrene, (meth)acrylamides or vinyl acetate, optionally combined with other monomers convertible by radical polymerization are copolymerized together with multi-functionalized vinyl group-containing monomers (“crosslinkers”). In order to prevent the material from being gelled, chain transfer agents are added. Examples of these are aliphatic or aromatic thiols or aliphatic halogen hydrocarbons. By varying the individual components (e.g. amount of chain transfer agents and/or crosslinkers) the architecture of the branched vinyl polymer (degree of branching, as well as molecular weight) can be modified and adjusted.

The use of these branched vinyl polymers to reduce volume shrinkage in laminated glass panes was described in EP 3 369 754 A1.

Due to the branched structure, these vinyl polymers have a comparatively low glass transition temperature in contrast to linear vinyl polymers. If branched vinyl polymers are now mixed with linear vinyl polymers, this results in a decrease in the glass transition temperature. In a homogeneous mixture, this can be described by the Fox equation:

1/T_{g}=ω₁/T_{g1}+ω₂/T_{g2}

Therein ω₁ and ω₂ are the individual weight proportions of the two polymers and T_{g1} and T_{g2} are the individual glass transition temperatures, respectively. Depending on the architecture, the glass transition temperature of the branched polymer can be adjusted. Thus, the proportion of the new plasticizer can be adjusted exactly to the desired properties of the final product (e.g. a plastic part). The more branches a polymer has, the lower the glass transition temperature of the polymer. This was already described by M. Chisholm, N. Hudson, N. Kirtley, F. Vilela and D. C. Sherrington in Macromolecules 2009, 42, 7745-7752.

The glass transition temperature is determined for the purposes of this description by dynamic differential calorimetry (DSC).

The compositions of the present invention have a number of advantages in addition to the easy accessibility of the components:
The glass transition temperature of a linear vinyl polymer can be reduced by adding branched vinyl polymers, making the material more flexible, softer and easier to process
The flowability of a linear vinyl polymer can be reduced by the addition of branched vinyl polymers, which lowers the viscosity of a polymer melt and makes the polymer melt easier to process or can be processed at lower temperatures
Due to the great variety and the high similarity of the usable branched vinyl polymers in relation to the plastic used, a very good miscibility is achievable
Since the new plasticizers or flow improvers are polymeric systems, outgassing of the plasticizer or flow improver does not take place
As a result of the chemical similarity to the plastic used, a release of the plasticizer or flow improver can only be achieved by simultaneously dissolving the plastic; therefore there is no enrichment of the plasticizer or flow improver at the interface
The manifold properties of the branched vinyl polymers used, such as their low viscosity in solution or their ability to reduce the polymerization shrinkage, make the use of certain additives and processing aids obsolete, although the addition of additives is quite possible; thus, the selected branched vinyl polymers of component b) can replace the use of further additives and thus are able to simplify the production process.

The thermoplastic vinyl polymers of component a) are preferably poly(meth)acrylates, poly(meth)acrylamides, polyethylenes, polypropylenes, polyvinyl aromatics, polyvinyl halides, polyvinylidene halides, polyvinyl ethers, polyvinyl alkanoates, polyvinyl alcohols or polyacrylonitriles, particularly preferred are poly(meth)acrylates, poly(meth)acrylamides, polyvinyl aromatics, polyvinyl halides, polyvinylidene halides, polyvinylethers, polyvinylalkanoates, polyvinyl alcohols or polycarylonitriles, and particularly preferred are poly(meth)acrylates, poly(meth)acrylamides, polyvinyl aromatics, polyvinyl halides or polyvinylidene halides.

Particularly preferred are compositions in which component a) contains the following polymers:
as polyethylenes polyethylene homopolymers or ethylene copolymers with other comonomers; or
as polypropylenes propylene homopolymers or propylene copolymers with other comonomers; or
as poly(meth)acrylates acrylate homopolymers, methacrylate homopolymers, acrylate copolymers with other comonomers or methacrylate copolymers with other comonomers; or
as poly(meth)acrylamides acrylamide homopolymers, methacrylamide homopolymers, acrylamide copolymers with other comonomers or methacrylamide copolymers with other comonomers; or
as polyvinyl aromatics polystyrene or styrene copolymers with other comonomers; or
as polyvinyl halides polyvinyl chloride or vinyl chloride copolymers with other comonomers; or
as polyvinylidene halides polyvinylidene chloride, polyvinylidene fluoride, vinylidene chloride copolymers with other comonomers or vinylidene fluoride copolymers with other comonomers; or
as polyvinyl ethers poly(C₁-C₆-alkylvinyl ether) or C₁-C₆-alkylvinyl ether copolymers with other comonomers; or
as polyvinylalkanoates vinyl acetate homopolymers or vinyl acetate copolymers with other comonomers; or
as polyvinyl alcohols vinyl alcohol homopolymers or vinyl alcohol copolymers with other comonomers; or
as polyacrylonitriles acrylonitrile homopolymers or acrylonitrile copolymers with other comonomers.

The branched vinyl polymers of component b), prepared according to the “Strathclyde method”, are preferably polyethylenes, polypropylenes, poly(meth)acrylates, poly(meth)acrylamides, polyvinyl aromatics, polyvinyl halides, polyvinylidene halides, polyvinyl ethers, polyvinyl alkanoates, polyvinyl alcohols or polyacrylonitriles, preferably poly(meth)acrylates, poly(meth)acrylamides, polyvinyl aromatics, polyvinyl halides, polyvinylidene halides, polyvinyl ethers, polyvinyl alkanoates, polyvinyl alcohols or polyacrylonitriles, and most preferred poly(meth)acrylates, poly(meth)acrylamides, polyvinyl aromatics, polyvinyl halides or polyvinylidene halides,

Particularly preferred are compositions which contain as component b) branched vinyl polymers, which derive from monofunctional vinyl compounds and from multifunctional, in particular from bifunctional vinyl compounds, which have been prepared by radical copolymerization in the presence of chain transfer agents, such as organic mercapto compounds or organic halogen compounds.

Particularly preferred are compositions in which component b) contains the following branched vinyl polymers produced according to the “Strathclyde method”
as polyethylenes copolymers derived from ethylene and from multifunctional, in particular bifunctional comonomers, in particular from multifunctional, in particular bifunctional vinyl compounds; or
as polypropylenes copolymers derived from propylene and from multifunctional, in particular bifunctional comonomers, preferably from multifunctional, in particular bifunctional vinyl compounds; or
as poly(meth)acrylates copolymers derived from monofunctional acrylates and from multifunctional, in particular bifunctional comonomers, in particular from multifunctional, in particular bifunctional acrylates or methacrylates, or copolymers derived from monofunctional methacrylates and from multifunctional, preferred bifunctional comonomers, in particular from multifunctional, preferred bifunctional acrylates or methacrylates, or
as poly(meth)acrylamides copolymers derived from monofunctional acrylamides and from multifunctional, preferred bifunctional comonomers, in particular from multifunctional, preferred bifunctional acrylamides or from multifunctional, preferred bifunctional methacrylamides, or copolymers derived from monofunctional methacrylamides and from multifunctional, preferred bifunctional comonomers, in particular from multifunctional, preferred bifunctional acrylamides or from multifunctional, preferred bifunctional methacrylamides, or
as polyvinyl aromatics copolymers derived from styrene and from multifunctional, preferred bifunctional comonomers, in particular from multifunctional, preferred bifunctional vinyl compounds; or
as polyvinyl halides copolymers derived from vinyl chloride and from multifunctional, preferred bifunctional comonomers, in particular from multifunctional, preferred bifunctional vinyl compounds; or
as polyvinylidene halides copolymers derived from vinylidene chloride or vinylidene fluoride and from multifunctional, preferred bifunctional comonomers, in particular from multifunctional, preferred bifunctional vinyl compounds; or
as polyvinyl ethers copolymers derived from C₁-C₆-alkyl vinyl ethers and from multifunctional, preferred bifunctional comonomers, in particular from multifunctional, preferred bifunctional vinyl compounds; or
as polyvinyl alkanoates copolymers derived from vinyl acetate and from multifunctional, preferred bifunctional comonomers, in particular from multifunctional, preferred bifunctional vinyl compounds; or
as polyvinyl alcohols copolymers derived from vinyl alcohol and from multifunctional, preferred bifunctional comonomers, in particular from multifunctional, preferred bifunctional vinyl compounds; or
as polyacrylonitriles copolymers derived from acrylonitrile and from multifunctional, preferred bifunctional comonomers, in particular from multifunctional, preferred bifunctional vinyl compounds.

The proportion of monofunctional vinyl compounds in the production of branched vinyl polymers is typically 99 to 50 wt %, preferably 95 to 60 wt %, and the proportion of multifunctional vinyl compounds in the production of branched vinyl polymers is typically 1 to 50 wt %, preferably 5 to 40 wt %, wherein the weights refer to the total mass of monofunctional vinyl compounds and multifunctional vinyl compounds.

The proportion of chain transfer agents in the production of hyperbranched vinyl polymers is typically 1 to 30 wt %, preferably 5 to 10 wt %, wherein the weight refers to the total mass of monofunctional vinyl compounds, multifunctional vinyl compounds and chain transfer agents.

Particularly preferred are compositions in which the thermoplastic vinyl polymers a) and the branched vinyl polymers b) belong to the same group of polymers.

These include, in particular, compositions, in which the thermoplastic vinyl polymers a) and the branched vinyl polymers b) each belong to the group of polyethylenes, polypropylenes, poly(meth)acrylates, poly(meth)acrylamides, polyvinyl aromatics, polyvinyl halides, polyvinylidene halides, polyvinyl ethers, polyvinyl alkanoates, polyvinyl alcohols or polyacrylonitriles.

The proportion of thermoplastic vinyl polymers a) in the compositions of the invention is typically 99 to 40 wt %, preferably 95 to 60 wt %, and the proportion of branched vinyl polymers b) in the compositions of the invention is typically 1 to 60 wt %, preferably 5 to 40 wt %, where the weights refer to the total mass of the linear vinyl polymers a) and the branched vinyl polymers b).

The molecular weight of the thermoplastic vinyl polymers used as component a) can vary in wide ranges. Typical values for the mean molecular weight (Mₙ=number average) of these polymers range from 10,000 g/mol to 5,000,000 g/mol, preferably from 100,000 g/mol to 1,000,000 g/mol. These values refer to the molecular weight determined by gel permeation chromatography (size exclusion chromatography).

The dispersity of the thermoplastic vinyl polymers used as component a) can vary in wide ranges. Typical values for the dispersity M_{w}/Mₙ (weight average/number average) of these polymers range from 1 to 10, preferably from 1 to 3. These values also refer to the molecular weights obtained by means of gel permeation chromatography (size exclusion chromatography).

The molecular weight of the branched vinyl polymers used as a component b) may also vary in wide ranges. Typical values for the mean molecular weight (Mₙ=number average) of these polymers range from 1,000 to 100,000 g/mol, preferably from 3,000 to 10,000 g/mol. These values refer to the molecular weight determined by gel permeation chromatography (size exclusion chromatography).

The dispersity of the branched vinyl polymers used as a component b) can also vary in wide ranges. Typical values for the dispersity M_{w}/Mₙ (weight average/number average) of these polymers range from 1 to 100, preferably from 2 to 10. These values also refer to the molecular weights obtained by means of gel permeation chromatography (size exclusion chromatography).

The branched vinyl polymers used as component b) can also be characterized by their Mark-Houwink parameter (α). Typical values for the parameter (α) of these polymers range from 0.1 to 0.7, preferably from 0.3 to 0.5. These values refer to the Mark-Houwink parameter determined by gel permeation chromatography (size exclusion chromatography).

The branched vinyl polymers used as component b) can also be characterized by their degree of branching (g′). Typical values for the factor (g′) of these polymers range from 0.1 to 1, preferably from 0.4 to 0.7. These values refer to the ratios of the intrinsic viscosities of the branched polymers in comparison to the intrinsic viscosities of linear polymers of comparable molecular weight, determined by gel permeation chromatography (size exclusion chromatography).

To the compositions of the invention containing components a) and b) conventional additives may be admixed in the melt or applied to the surface as component c), in particular release agents, stabilizers and/or other flow promoters.

Other possible additives, components c), include fillers and/or reinforcing agents as well as antioxidants, UV stabilizers, hydrolysis stabilizers, co-stabilizers for antioxidants, antistatics, emulsifiers, nucleation agents, other plasticizers, processing aids, impact modifiers, dyes, pigments and/or flame retardants.

The compositions of the invention can be produced by mixing each other the thermoplastic vinyl polymers a) and the branched vinyl polymers b) and optionally the additives c) in the desired relation.

The mixing can be performed in the usual devices, for example in an extruder.

The invention also relates to the use of branched vinyl polymers prepared according to the “Strathclyde method” as plasticizers for thermoplastic vinyl polymers or as flow improvers for fluids.

In this process, as component b) in particular the branched vinyl polymers described above as preferred are used; as component a) the thermoplastic vinyl polymers described above as preferred are used.

The following examples explain the invention without limiting it.

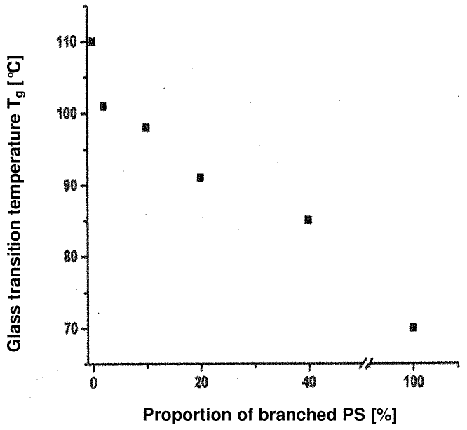

Subsequently the plasticising effect is illustrated by the example of polystyrene as well as poly(methyl methacrylate). FIG. 1 shows the change in glass transition temperature of a polystyrene blend comprising different proportions of highly branched polystyrene as a plasticizer replacement. Even small amounts of the highly branched polymer have a strong influence on the glass transition temperature of the blend. Also in examples 1 to 4 the influence of the branched polymers on the fluidity can be demonstrated using the example of polystyrene.

### EXAMPLE A

The branched polystyrene described in Examples 1˜4 was produced as follows:

80 g of styrene were dissolved together with 3.8 g of tripropylene glycol diacrylate and 2.6 g of dodecane thiol in 80 mL dioxane. Subsequently, 0.765 g of azobis (isobutyronitrile) were added and the reaction mixture was degassed with argon for 15 min. The reaction mixture was then heated to 80° C. for 4 h. The branched polystyrene was purified by precipitation in methanol and then dried. The obtained polymer had a glass transition temperature of approximately 70° C. By means of size exclusion chromatography with coupled triple detection, a molecular weight distribution of 5,500 g/mol (Mₙ) and a dispersity of 10.8 was determined. Also a Mark Houwink parameter (α) of 0.44, respectively a branching degree (contraction factor g′) of approx. 0.61 was determined.

### EXAMPLE 1

To a linear polystyrene with a weight-average molecular weight (M_{w}) of 350,000 g/mol, a glass transition temperature of 110° C. and a melt flow of 4.4 g/10 min 2 wt. % of the branched polystyrene were added. After both components were mixed (extruded), the glass transition temperature, as well as the melt flow of the mixture were determined by means of dynamic differential calorimetry and by means of a melt flow indexer (at 230° C. and a weight of 3.8 kg) were determined. With 101° C., the glass transition temperature was significantly lower than that of the linear polymer. The melt flow of 7.1 g/10 min, however, was above that of the linear polymer.

### EXAMPLE 2

To a linear polystyrene with a weight-average molecular weight (M_{w}) of 350,000 g/mol, a glass transition temperature of 110° C. and a melt flow of 4.4 g/10 min 10 wt. % of the branched polystyrene were added. After both components were mixed (extruded), the glass transition temperature, as well as the melt flow of the mixture were determined by means of dynamic differential calorimetry and by means of a melt flow indexer (at 230° C. and a weight of 3.8 kg). With 98° C., the glass transition temperature was significantly lower than that of the linear polymer. The melt flow of 12.6 g/10 min, however, was above that of the linear polymer.

### EXAMPLE 3

To a linear polystyrene with a weight-average molecular weight (M_{w}) of 350,000 g/mol, a glass transition temperature of 110° C. and a melt flow of 4.4 g/10 min 20 wt. % of the branched polystyrene were added. After both components were mixed (extruded), the glass transition temperature, as well as the melt flow of the mixture were determined by means of dynamic differential calorimetry and by means of a melt flow indexer (at 230° C. and a weight of 3.8 kg). With 91° C., the glass transition temperature was significantly lower than that of the linear polymer. The melt flow of 19.7 g/10 min, however, was above that of the linear polymer.

### EXAMPLE 4

To a linear polystyrene with a weight-average molecular weight (M_{w}) of 350000 g/mol, a glass transition temperature of 110° C. and a melt flow of 4.4 g/10 min 40 wt. % of the branched polystyrene were added. After both components were mixed (extruded), the glass transition temperature, as well as the melt flow of the mixture were determined by means of dynamic differential calorimetry and by means of a melt flow indexer (at 230° C. and a weight of 3.8 kg). With 85° C., the glass transition temperature was significantly lower than that of the linear polymer. The melt flow of 24.3 g/10 min, however, above that of the linear polymer.

FIG. 1 shows the change in the glass transition temperature of a polystyrene blend at different proportions of branched polystyrene.

### EXAMPLE B

The branched poly(methyl methacrylate) described in Examples 5-8 was prepared as follows:

15 g methyl methacrylate were dissolved together with 0.45 g of tripropylene glycol diacrylate and 1.5 g of dodecane thiol in 15 mL of toluene. Subsequently, 86 mg of azobis-(isobutyronitrile) were added and the reaction mixture was degassed for 15 min with argon. The reaction mixture was then heated to 80° C. for 4 h. The branched poly(methyl methacrylate) was purified by precipitation in n-hexane and then dried. The obtained polymer had a glass transition temperature of approx. 56° C. By means of size exclusion chromatography with coupled triple detection, a molecular weight distribution of 3,000 g/mol (Mₙ) and a dispersity of 4.1 was determined.

### EXAMPLE 5

To a linear poly(methyl methacrylate) with a weight-average molecular weight (M_{w}) of 120,000 g/mol and a glass transition temperature of 105° C. 2 wt % of the branched poly(methyl methacrylate) were added. After both components were mixed (extruded), the glass transition temperature of the mixture was determined by means of dynamic differential calorimetry. This was with 99° C. below the glass transition temperature of the linear polymer.

### EXAMPLE 6

To a linear poly(methyl methacrylate) with a weight-average molecular weight (M_{w}) of 120,000 g/mol and a glass transition temperature of 105° C. 10 wt % of the branched poly(methyl methacrylate) were added. After both components were mixed (extruded), the glass transition temperature of the mixture was determined by means of dynamic differential calorimetry. With 94° C., this was significantly below the glass transition temperature of the linear polymer

### EXAMPLE 7

To a linear poly(methyl methacrylate) with a weight-average molecular weight (M_{w}) of 120,000 g/mol and a glass transition temperature of 105° C. 20 wt % of the branched poly(methyl methacrylate) were added. After both components were mixed (extruded), the glass transition temperature of the mixture was determined by means of dynamic differential calorimetry. With 87° C., this was significantly below the glass transition temperature of the linear polymer.

### EXAMPLE 8

To a linear poly (methyl methacrylate) with a weight-average molecular weight (M_{w}) of 120,000 g/mol and a glass transition temperature of 105° C. 40 wt % of the branched poly(methyl methacrylate) were added. After both components were mixed (extruded), the glass transition temperature of the mixture was determined by means of dynamic differential calorimetry. With 76° C., this was significantly below the glass transition temperature of the linear polymer.

1. Compositions comprising
a) thermoplastic vinyl polymers, and
b) branched vinyl polymers which are derived from monofunctional vinyl compounds and from multifunctional vinyl compounds, and which have been prepared by radical copolymerisation in the presence of chain transfer agents.

2. Compositions according to claim 1, wherein the thermoplastic vinylpolymers a) are selected from the group of polyethylenes, polypropylenes, poly(meth)-acrylates, poly(meth)acrylamides, polyvinyl aromatics, polyvinyl halides, polyvinylidene halides, polyvinyl ethers, polyvinyl alkanoates, polyvinyl alcohols and polyacrylonitriles.

3. Compositions according to claim 2, wherein the polyethylenes are polyethylene-homopolymers or ethylene-copolymers with other comonomers, the polypropylenes are propylene-homopolymers or propylene copolymers with other comonomers, the poly(meth)acrylates are acrylate-homopolymers, methacrylate-homopolymers, acrylate-copolymers with other comonomers or methacrylate-copolymers with other comonomers, the poly(meth)acrylamides are acrylamide-homopolymers, methacrylamide-homopolymers, acrylamide-copolymers with other comonomers or methacrylamide-copolymers with other comonomers, the polyvinyl aromatics are polystyrene or styrene-copolymers with other comonomers, the polyvinyl halides are polyvinyl chloride or vinylchloride-copolymers with other comonomers, the polyvinylidene halides are polyvinylidene chloride, polyvinylidene fluoride, vinylidene chloride-copolymers with other comonomers or vinylidene fluoride-copolymers with other comonomers, the polyvinyl ethers are poly(C₁-C₆-alkyl-vinyl ethers) or C₁-C₆-alkylvinyl ether-copolymers with other comonomers, the polyvinyl alkanoates are vinylacetate-homopolymers or vinylacetate-copolymers with other comonomers, the polyvinyl alcohols are vinylalcohol-homopolymers or vinylalcohol-copolymers with other comonomers, or the polyacrylonitriles are acrylonitrile-homopolymers or acrylonitrile-copolymers with other comonomers.

4. Compositions according to claim 1, wherein the branched vinylpolymers b) are selected from the group of polyethylenes, polypropylenes, poly(meth)acrylates, poly(meth)acrylamides, polyvinyl aromatics, polyvinyl halides, polyvinylidene halides, polyvinyl ethers, polyvinyl alkanoates, polyvinyl alcohols and polyacrylonitriles.

5. Compositions according to claim 1, wherein the multifunctional vinyl compounds are bifunctional vinyl compounds and the chain transfer agents are organic mercapto compounds or organic halogen compounds.

6. Compositions according to claim 4, wherein the polyethylenes are copolymers derived from ethylene and from multifunctional vinyl compounds, or the polypropylenes are copolymers derived from propylene and from multifunctional vinyl compounds, or the poly(meth)acrylates are copolymers derived from monofunctional acrylates and from multifunctional acrylates or methacrylates, or are copolymers derived from monofunctional methacrylates and from multifunctional acrylates or methacrylates, or the poly(meth)acrylamides are copolymers derived from monofunctional acrylamides and from multifunctional acrylamides or from multifunctional methacrylamides, or are copolymers derived from monofunctional methacrylamides and from multifunctional acrylamides or from multifunctional methacrylamides, or the polyvinyl aromatics are copolymers derived from styrene and from multifunctional vinyl compounds, or the polyvinyl halides are copolymers derived from vinyl chloride and from multifunctional vinyl compounds, or the polyvinylidene halides are copolymers derived from vinylidene chloride or vinylidene fluoride and from multifunctional vinyl compounds, or the polyvinyl ethers are copolymers derived from C₁-C₆-alkylvinyl ethers and from multifunctional vinyl compounds, or the polyvinyl alkanoates are copolymers derived from vinyl acetate and from von multifunctional vinyl compounds, or the polyvinyl alcohols are copolymers derived from vinyl alcohol and from multifunctional vinyl compounds, or the polyacrylonitriles are copolymers derived from acrylonitrile and from multifunctional vinyl compounds.

7. Compositions according to claim 1, wherein a proportion of the monofunctional vinyl compounds is 99 to 50 wt %, and a proportion of the multifunctional vinyl compounds is 1 to 50 wt %, wherein the weights refer to the total mass of monofunctional vinyl compounds and multifunctional vinyl compounds.

8. Compositions according to claim 1, wherein a proportion of the chain transfer agents is 1 to 30 wt %, wt % being based on the total mass of monofunctional vinyl compounds, multifunctional vinyl compounds and chain transfer agents.

9. Compositions according to claim 1, wherein the thermoplastic vinyl polymers a) and the branched vinyl polymers b) belong to the same group of polymers.

10. Compositions according to claim 9, wherein the thermoplastic vinylpolymers a) and the branched vinylpolymers b) each belong to the group of polyethylenes, polypropylenes, poly(meth)acrylates, poly(meth)acrylamides, polyvinyl aromatics, polyvinyl halides, polyvinylidene halides, polyvinylethers, polyvinyl alkanoates, polyvinyl alcohols or polyacrylonitriles.

11. Compositions according to claim 1, wherein a proportion of thermoplastic vinyl polymers a) is 99 to 40 wt %, and a proportion of branched vinyl polymers b) is 1 to 60 wt %, wt % being based on the total mass of the components a) and b).

12. A process for the manufacture of the compositions according to claim 1, wherein the thermoplastic vinylpolymers a) and the branched vinylpolymers b) are mixed in desired proportions.

13. Branched vinylpolymers derived from monofunctional vinyl compounds and from multifunctional vinyl compounds and which have been prepared by radical copolymerisation in the presence of chain transfer agents, the branched vinylpolymers being adapted as plasticizers for thermoplastic vinylpolymers.

14. The plasticisers for thermoplastic vinylpolymers according to claim 13, wherein the branched vinylpolymers are selected from the branched vinylpolymers of claim 1.

15. The plasticizers for thermoplastic vinylpolymers of claim 13, further comprising the thermoplastic vinylpolymers of claim 1.

16. Branched vinylpolymers derived from monofunctional vinyl compounds and from multifunctional vinyl compounds and which have been prepared by radical copolymerisation in the presence of chain transfer agents, wherein the branched vinylpolymers are adapted as flow improvers for fluids.
